(19) United States
(12) Patent Application Publication
(10) Pub. No.: US 2004/0150714 A1
(43) Pub. Date: Aug. 5, 2004

(54) Optical-enhanced apparatus and method for illuminating printed circuit boards for inspection

(75) Inventor: Don Lin, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Test Research, Inc., Taipei (TW)

(21) Appl. No.: 10/611,198

(22) Filed: Jul. 1, 2003

(30) Foreign Application Priority Data
Jan. 30, 2003 (TW) 92102333

(51) Int. Cl. H04N 7/18

(52) U.S. Cl. 348/126

(57) ABSTRACT

The apparatus includes: an illumination system having a planar printed circuit board, and a plurality of light producing elements mounted on the planar printed circuit board and divided into at least one area, a control system, wherein the light producing elements can be selected from at least one area and lighted to illuminate by the control system, and a flat thin lens system in front of and connected to the illumination system to focus the lights emitted from the light producing elements onto any position of the printed circuit board. The method applied to proposed apparatus includes steps of: (a) choosing a position, (b) setting the illumination conditions, (c) producing the required illumination through focusing the lights on the chosen position, (d) recording the image of chosen position, (e) displaying the image, (f) comparing the recording image with the referencing image, and (g) making a record of comparison.

### FIELD OF THE INVENTION

The present invention relates to the apparatus and method for illuminating printed circuit boards for inspection. More specifically, this invention includes the apparatus and method of an optical-enhanced lighting system for using with the series of cameras associated with the printed circuit board inspecting device.

### BACKGROUND OF THE INVENTION

The optical inspection systems have been applied in many areas in industries to reduce the manpower of quality control, prolong the working hour, and prevent human errors, such as, searching for the dust particles in a semi-conductor process, accurate positioning, and inspecting for missing and wrong components or soldering defects such as open circuits, short circuit in the composition process of a circuit board. To fulfill the above mentioned purposes, the Automated Optical Inspection Systems (AOI Systems) with a imaging system having multiple CCD (charge couple device) cameras for taking well-illuminated video images from multiple angles, and a micro-processor system for storing taken video images and comparing the results from the newly taken video images to the standard no-fault images has been employed in the high-speed production lines of the electronic industry. Nowadays, the AOI Systems must have the functions for the three-dimensional inspections to cope with the requirements of inspection regarding the altitude of the component and the trend of more and more miniaturization of fine-pitch ICs and SMDs (surface mount device).

The suppliers of various AOI systems are trying to offer their customers with new products having more advanced functions and higher speed for inspection as well as the new applications in new areas.

To make an entry level Automatic Optical Inspection (AOI) System is not a difficult thing to do. To be among the best is the challenge. Most of the machine vision key components including: double speed/quad speed CCD cameras, camera lenses, XY table, and imaging grabber cards are available in high industrial quality. The only exception is the illumination system, the soul of AOI system, AOI makers have various solutions developed by their own.

Most AOI system makers use high bright light emitting diodes (LED) for illumination, such as SONY/VARIA, Teradyne, OMROM, MVP, HP/MVT, Samsung, and LG. Only Orbotech uses xenon flashes and SAKI uses fluorescent illuminators.

Currently, most types of LED illumination devices can be found in companies like CCS Inc. Limited by the area CCD camera sensor size, to achieve a 20 um optical resolution, the inspection area per field of view (FOV) can be only the sizes from 12 mm×9 mm to 24 mm×18 mm. The brighter the illumination is, the larger the depth of field or the higher shutter speed can be. How to focus all available lights onto a spot determines the destiny of the system performance. Each type of commercial product available on the market offers only a single dedicate type of illumination, for example: direct, diffused, low angle, ambient, etc. Using various combinations of different types of illumination in AOI systems are possible with penalty of larger size and higher control complexity of the illumination system. Nowadays, the venders of AOI systems develop their own illumination systems with integrated lighting control capability down to section or even single individual LED level to fulfill the illumination control multiplicity. To achieve an ambient and uniformity illumination, diffusers are often used, especially at a close distance (See FIG. 1). However, the light output is relatively reduced. To align each LED toward the target, a dome shape structure with complicated fixtures is also applied with drawbacks of low LED placement density and short clearance/working distance (See FIG. 2). To get the maximal LED placement density within a limited space, a multi-faceted or C-shape flexible substrate is used to form stereo space ring lighting but not focused to a spot (See FIG. 3).

Therefore, how to create an illumination system with strong, bright, uniform light and focused on a spot in a very simple physical structure is the goal. The Patents related to the prior arts include: U.S. patent Ser. No. 5,060,065, and U.S. patent Ser. No. 5,245,421.

Keep the drawbacks of the prior arts in mind, and employ experiments and research full-heartily and persistently, the optical-enhanced apparatus and method for illuminating printed circuit boards for inspection are finally conceived by the applicant.

### SUMMARY OF THE INVENTION

It is therefore an object of the present invention to propose an optical-enhanced apparatus for illuminating a printed circuit board for inspection.

It is therefore another object of the present invention to propose a method for illuminating a printed circuit board for inspection.

According to the aspect of the present invention, the apparatus for inspecting the printed circuit board includes: an illumination system having a planar printed circuit board and a plurality of light producing elements in which the plurality of light producing elements arranged in planar high-density arrays mounted on and electrically connected to the planar printed circuit board and the illumination system divided into at least one area according to distances away from a central referencing point of the illumination system, a control system electrically connected to the illumination system wherein the plurality of light producing elements of the illumination system are selected from at least one area and lighted by the control system, and a flat thin lens system having at least one flat thin lens wherein at least one flat thin lens placed in front of and tightly connected to the illumination system to focus the lights emitted from the plurality of light producing elements onto any position of the printed circuit board.

Preferably, the light producing elements are light emitting diodes.

Preferably, the flat thin lens is a Fresnel Lens.

Preferably, the apparatus further includes a camera system having at least one camera to receive reflected lights of the printed circuit board originally emitted from the plurality of light producing elements.

Preferably, the at least one camera is mounted right behind one selected from a group consisting of the central referencing point of the illumination system and a plurality of locations that are equally distanced from the central referencing point respectively.

Preferably, the at least one area can be divided into a central area and at least one peripheral area according to distances away from the central referencing point of the illumination system.

Preferably, each of the at least one peripheral area can be further divided into at least one sub-area according to the distances and directions away from the central referencing point of the illumination system.

Preferably, the control system controls each of the plurality of light producing elements of the at least one area in one of on and off status and each of the camera of the camera system in one of on and off status to produce a permutation of illumination conditions including a projecting direction, a projecting angle, and an luminous intensity shedding light on any position of the printed circuit board by the illumination system and to choose at least one camera to record an image of a certain range centered by any position and illuminated by the illumination system when at least one light producing element of at least one area is lighted.

Preferably, the certain range includes a size decided by a size of sensor of the camera and a requirement of inspecting resolution.

Preferably, the apparatus further includes a display system having at least one display to show the image on a display screen.

Preferably, the apparatus further includes at least one microprocessor system to compare the image with a referencing image record of the certain range to decide whether or not a difference existing and to memorize in the microprocessor system.

Preferably, the printed circuit board could be at any stage of a process for mounting electronic elements on the printed circuit board.

According to another aspect of the present invention, a method using an apparatus having an illumination system with a plurality of light emitting diodes arranged in high-density arrays on a plane divided into at least one area, a flat thin lens system with at least one flat thin lens, a camera system with at least one camera, a control system, a microprocessor system with at least one microprocessor, and a display system with at least one display to inspect a printed circuit board includes steps of: (a) choosing a position on the printed circuit board, (b) setting a combination of illumination conditions including a projecting direction, a projecting angle, and an illumination strength according to a configuration of the printed circuit board in a certain range using the position as a referencing center, (c) using the control system to let at least one of the plurality of light emitting diodes of at least one area of the illumination system be lighted, and to focus the emitted lights onto the position through the flat thin lens of the illumination system to produce the combination of illumination conditions on the position, (d) employing the control system to start at least one camera to record a video image of the position illuminated by the illumination system according to the combination of illumination conditions of the position when at least one of the plurality of light emitting diodes of at least one area of the illumination system is in “on” status, (e) displaying the video image of the position taking by at least one started camera on a display screen of the display system according to the combination of illumination conditions of the position, (f) comparing a referencing image record of the position stored in the microprocessor system with the video image of the position to decide whether or not a difference existing, and (g) recording whether or not a difference existing between the video image of the position and the referencing image record of the position in the microprocessor system.

Preferably, the at least one camera of the camera system is mounted right behind one selected from a group consisting of the central referencing point of the illumination system and a plurality of locations equally distanced from the central referencing point respectively.

Preferably, the at least one area can be divided into a central area and at least one peripheral area according to distances away from the central referencing point of the illumination system.

Preferably, each of the at least one peripheral area can be further divided into at least one sub-area according to distances and directions away from the central referencing point of the illumination system.

Preferably, the certain range having a size decided by a size of sensor of the camera and a requirement of inspecting resolution.

Preferably, the flat thin lens is a Fresnel Lens and is placed in front of and tightly connected to the light emitting diodes to focus the lights emitted from the plurality of light emitting diodes onto any position of the printed circuit board.

Preferably, the printed circuit board could be at any stage of a process for mounting electronic elements on the printed circuit board.

The present invention may best be understood through the following descriptions with reference to the accompanying drawings, in which:

### BRIEF DESCRIPTION OF THE DRAWINGS

FIG. 1 is the schematic diagram of an illumination system of AOI system with flat LED arrays;

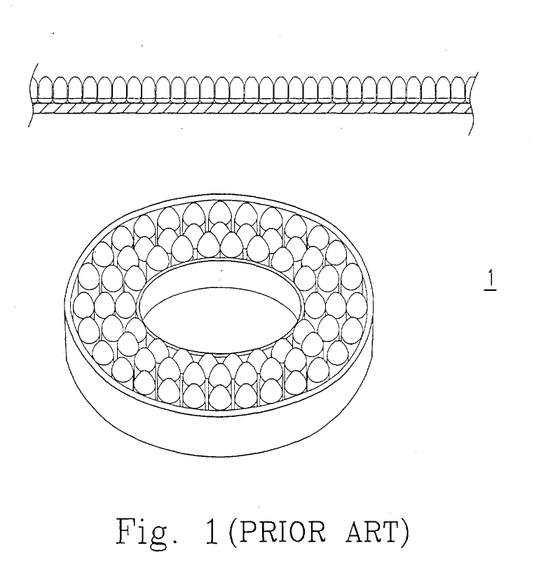

FIG. 2 is the schematic diagram of an illumination system of AOI system with a dome shape structure which aligns each LED on it toward the target;

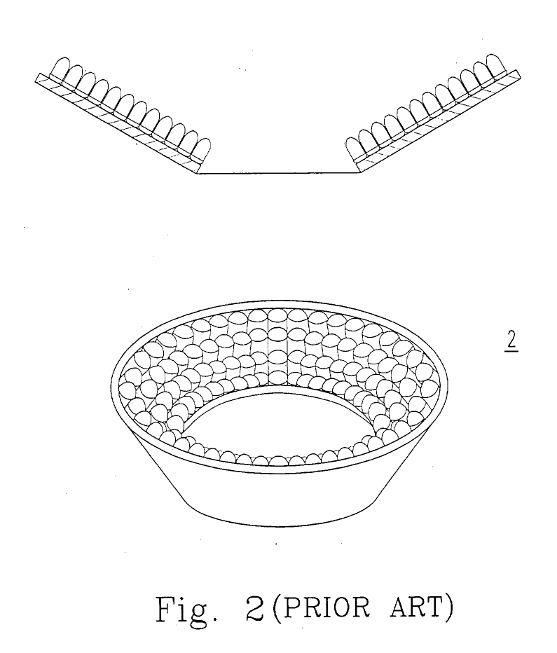

FIG. 3 is the schematic diagram of an illumination system of AOI system with a multi-layered LED arrays arranged in an umbrella configuration;

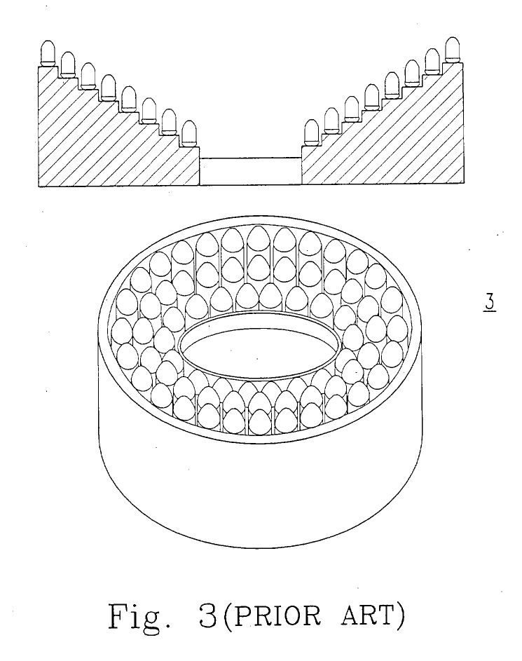

FIG. 4 is the schematic diagram of the optical fundamentals of Fresnel Lens;

FIG. 5 is the schematic diagram showing the side view of the illumination system of the present invention; and

FIG. 6 is the schematic diagram showing the bottom view of the illumination system of the present invention.

### DETAILED DESCRIPTION OF THE PREFERRED EMBODIMENT

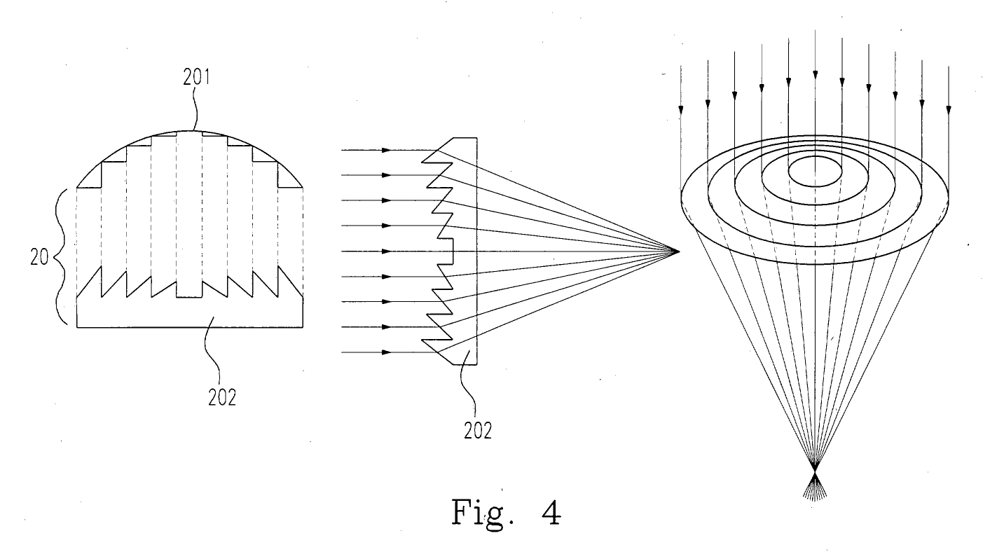

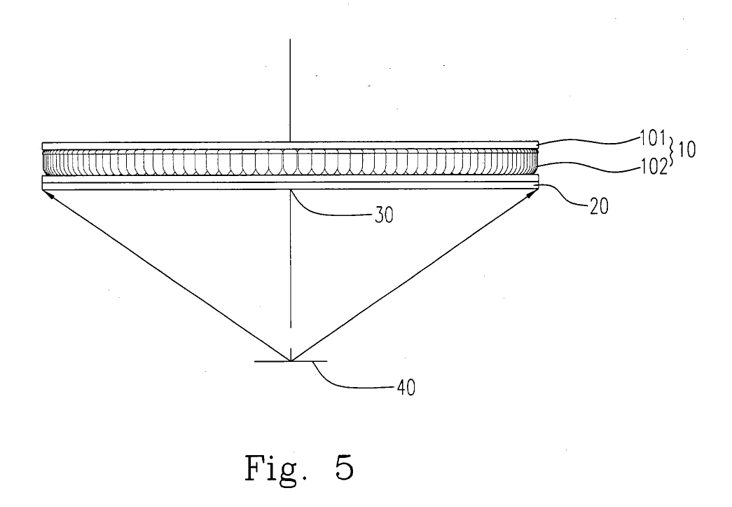

To create a strong light and focused on a spot at a very simple manufacture process, the simple lens deflection formula is applied. Please refer to FIG. 4, an optical lenses system of infinite to finite conjugate design can gather all parallel light rays in to a spot at the lenses focal point. Please refer to FIG. 5, if a lenses system 20 is place in front of a plate 101 with LEDs 102 fully mounted, then this lens 20 will gather all of the LEDs lights onto a small region of area to be inspected 40. Because of the LEDs 102 are arranged in high-density planar arrays as an illumination system 10 at a relative longer working distance, this illumination system 10 can be used as a high uniformity ambient-like coherent light source.

Please refer to FIG. 5, since light rays are optically bended onto the target 40, the illumination system 10 is capable of a continuously ambient-like illumination form near 0 degree perpendicularly (coaxial lighting) to virtually 90 degree (ring/side lighting) with infinity size of the disk or plate. In practice, to save the space and cost of this optical lenses system, one or a group of Fresnel Lenses 20 are used right in front of LEDs 102 to gather the lights (See FIGS. 4 and 5). It is a reverse usage of the lens optics that normally used for various projection applications that port a bulb light (point light source) onto a screen. Point light sources are used in most applications. In the prior art, the planar LED array is used only for direct and indirect (without and with diffuser respectively) surface light sources, simulation of parallel coherent light source as sunlight and focused onto a spot is not existing till the present invention.

Please refer to FIG. 4, Fresnel Lens 202 is a transparent optical material thin plan with capability of focus light rays onto one point like ordinary optical lens. It is basically slicing an optical lens 201 ring by ring and shrinking the lens thickness down to a flat thin lens (namely, a Fresnel Lens 202). It is to replace the large optical lens especially in non-image/light source collection system to save space and cost. An illumination system using Fresnel Lens 202 can be employed not only in improving the accuracy of inspection and accelerate the speed of taking images of the AOI system, but also in other similar usages which need the optical illumination for comparisons whether the surface of the object being inspected having flaws. Except for the inspection of a printed circuit board, examples are the surface inspection for the flaws of an electronic element like a diode, the surface inspection for the flaws of IC chips and so on.

Please refer to FIG. 5, it is the schematic diagram showing the side view of the illumination system 10 of the present invention. The apparatus for inspecting a printed circuit board includes: an illumination system 10 having a planar printed circuit board 101 and a plurality of light emitting diodes 102 wherein the plurality of light emitting diodes 102 arranged in planar high-density arrays mounted on and electrically connected to the planar printed circuit board 101 and the illumination system 10 divided into at least one area according to distances away from a central referencing point 30 of the illumination system 10, a control system (not shown) electrically connected to the illumination system 10 wherein the plurality of light emitting diodes 102 of the illumination system 10 can be selected from at least one area and be lighted by the control system, and a flat thin lens system 20 having at least one flat thin lens 20 wherein at least one flat thin lens 20 placed in front of and tightly connected to the illumination system 10 to focus the lights emitted from the plurality of light emitting diodes 102 onto any position of the printed circuit board 40.

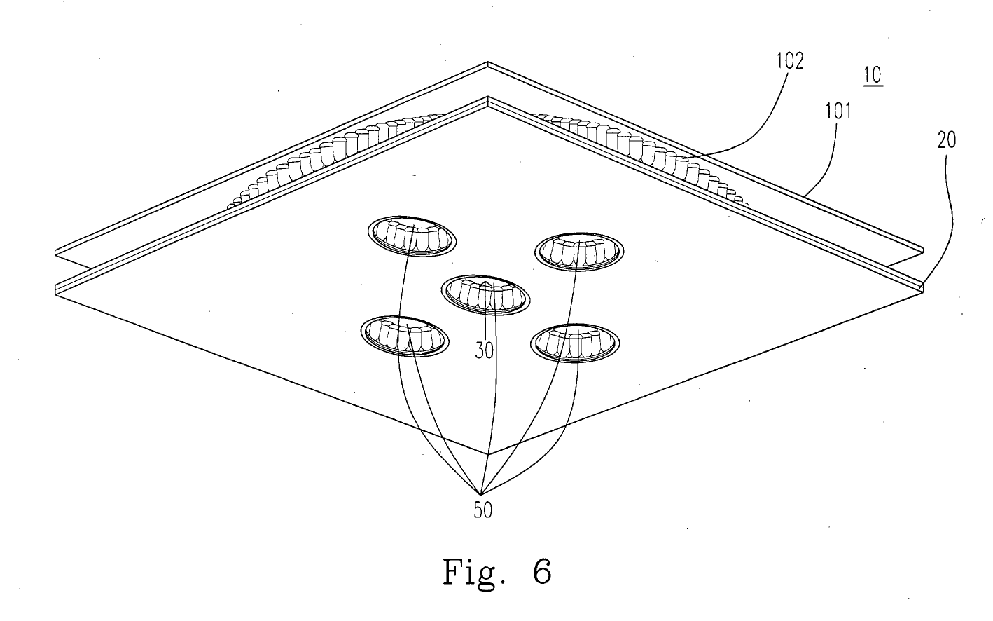

Please refer to FIGS. 5 and 6, the apparatus further includes a camera system 50 having at least one camera to receive reflected lights of an object being inspected like a printed circuit board 40 originally emitted from the plurality of light emitting diodes 102. The at least one camera 50 is mounted right behind one selected from a group consisting of the central referencing point 30 of the illumination system 10 and a plurality of locations that are equally distanced from the central referencing point 30 respectively. The at least one area can be divided into a central area and at least one peripheral area according to distances away from the central referencing point 30 of the illumination system 10. Each of the at least one peripheral area can be further divided into at least one sub-area according to the distances and directions away from the central referencing point 30 of the illumination system 10. The control system controls each of the plurality of light emitting diodes 102 of the at least one area in one of on and off status and each of the camera of the camera system 50 in one of on and off status to produce a combination of illumination conditions including a projecting direction, a projecting angle, and an illumination strength illuminating onto any position of the printed circuit board 40 by the illumination system 10 and to choose at least one camera 50 to record an image of a certain range centered by any position and illuminated by the illumination system 10 when at least one light emitting diodes 102 of the at least one area is lighted. The certain range includes a size decided by a size of sensor of the camera 50 and a requirement of inspecting resolution.

The apparatus further includes a display system (not shown) having at least one display to show the image on a display screen. The apparatus further includes at least one microprocessor system to compare the image with a referencing image record of the certain range to decide whether or not a difference existing and to memorize in the microprocessor system. The printed circuit board 40 could be at any stage of a process for mounting electronic elements on the printed circuit board 40.

Please refer to FIGS. 5 and 6 again, a method using an apparatus having an illumination system 10 with a plurality of light emitting diodes arranged in high-density arrays 102 on a plane divided into at least one area, a flat thin lens system 20 with at least one flat thin lens, a camera system 50 with at least one camera, a control system (not shown), a microprocessor system (not shown) with at least one microprocessor, and a display system (not shown) with at least one display to inspect a printed circuit board 40 includes steps of: choosing a position on the printed circuit board 40, setting a combination of illumination conditions including a projecting direction, a projecting angle, and an illumination strength according to a configuration of the printed circuit board 40 in a certain range using the position as a referencing center, using the control system to let at least one of the plurality of light emitting diodes 102 of at least one area of the illumination system 10 be lighted and to focus the emitted lights onto the position through the flat thin lens 20 of the illumination system 10 to produce the combination of illumination conditions on the position, employing the control system to start at least one camera 50 to record a video image of the position illuminated by the illumination system 10 according to the combination of illumination conditions of the position when at least one of the plurality of light emitting diodes 102 of at least one area of the illumination system 10 is in “on” status, displaying the video image of the position taking by at least one started camera 50 on a display screen of the display system according to the combination of illumination conditions 10 of the position, comparing a referencing image record of the position stored in the microprocessor system with the video image of the position to decide whether or not a difference existing, and recording whether or not a difference existing between the video image of the position and the referencing image record of the position in the microprocessor system. The at least one camera of the camera system 50 is mounted right behind one selected from a group consisting of the central referencing point 30 of the illumination system 10 and a plurality of locations equally distanced from the central referencing point 30 respectively. The at least one area can be divided into a central area and at least one peripheral area according to distances away from the central referencing point of the illumination system. Each of the at least one peripheral area can be further divided into at least one sub-area according to distances and directions away from the central referencing point 30 of the illumination system 10. The certain range having a size decided by a size of sensor of the camera 50 and a requirement of inspecting resolution. The flat thin lens 20 is a Fresnel Lens and is placed in front of and tightly connected to the light emitting diodes 102 to focus the lights emitted from the plurality of light emitting diodes 102 onto any position of the printed circuit board 40. The printed circuit board 40 could be at any stage of a process for mounting electronic elements on the printed circuit board 40.

Although the present invention has been described and illustrated in an example of the most preferred embodiment, the constructional characteristics of the present invention are not limited by that. The variations and modifications that anyone who is familiar with the skill can think of easily which fall within the spirit and scope of the present invention as defined by the appended claims should be included.

What is claimed is:

1. An apparatus for inspecting a printed circuit board, comprising:
an illumination system having a planar printed circuit board, and a plurality of light producing elements in which said plurality of light producing elements are arranged in planar high-density arrays mounted on and electrically connected to said planar printed circuit board, and said illumination system is divided into at least one area according to distances away from a central reference point of said illumination system;
a control system electrically connected to said illumination system, wherein said plurality of light producing elements of said illumination system are selected from at least one said area and lighted by said control system; and
a flat thin lens system having at least one flat thin lens, wherein said at least one flat thin lens is placed in front of and tightly connected to said illumination system to focus the lights emitted from said plurality of light producing elements onto any position of said printed circuit board.

2. The apparatus according to claim 1, wherein said plurality of light producing elements are light emitting diodes.

3. The apparatus according to claim 1, wherein said flat thin lens is a Fresnel Lens.

4. The apparatus according to claim 1, wherein said apparatus further comprises a camera system having at least one camera to receive reflected lights of said printed circuit board originally emitted from said plurality of light producing elements.

5. The apparatus according to claim 4, wherein said camera is mounted right behind one selected from a group consisting of said central reference point of said illumination system and a plurality of locations that are equally distanced from said central reference point respectively.

6. The apparatus according to claim 5, wherein said at least one area can be divided into a central area and at least one peripheral area according to distances away from said central reference point of said illumination system.

7. The apparatus according to claim 6, wherein each of said peripheral area can be further divided into at least one sub-area according to distances and directions away from said central reference point of said illumination system.

8. The apparatus according to claim 6, wherein said control system controls each of said plurality of light producing elements of said area in one of on and off status and each of said camera of said camera system in one of on and off status to produce a combination of illumination conditions comprising a projecting direction, a projecting angle, and an illumination strength illuminated onto any position of said printed circuit board by said illumination system and to choose at least one said camera to record an image of a certain range centered by said position and illuminated by said illumination system when at least one said light producing element of at least one said area is lighted.

9. The apparatus according to claim 8, wherein said certain range having a size decided by a size of sensor of said camera and a requirement of inspecting resolution.

10. The apparatus according to claim 8, wherein said apparatus further comprises a display system having at least one display to show said image on a display screen.

11. The apparatus according to claim 8, wherein said apparatus further comprises at least one microprocessor system to compare said image with a reference image record of said certain range to decide whether or not a difference existed and to be memorized in said microprocessor system.

12. The apparatus according to claim 1, wherein said printed circuit board could be at any stage of a process for mounting electronic elements on said printed circuit board.

13. A method using an apparatus having an illumination system with a plurality of light emitting diodes arranged in high-density arrays on a plane divided into at least one area, a flat thin lens system with at least one flat thin lens, a camera system with at least one camera, a control system, a microprocessor system with at least one microprocessor, and a display system with at least one display to inspect a printed circuit board, comprising steps of:
(a) Choosing a position on said printed circuit board;
(b) Setting a combination of illumination conditions comprising a projecting direction, a projecting angle, and an illumination strength according to a configuration of said printed circuit board in a certain range using said position as a reference center;
(c) Using said control system to let at least one of said plurality of light emitting diodes of at least one said area of said illumination system be lighted, and to focus emitted lights onto said position through said flat thin lens of said illumination system to produce said combination of illumination conditions on said position;
(d) Employing said control system to start at least one said camera to record a video image of said position illuminated by the illumination system according to said combination of illumination conditions of said position when at least one of said plurality of light emitting diodes of at least one said area of said illumination system is in “on” status;
(e) Displaying said video image of said position taken by at least one said started camera on a display screen of said display system according to said combination of illumination conditions of said position;
(f) Comparing a reference image record of said position stored in said microprocessor system with said video image of said position to decide whether or not a difference existed; and
(g) Recording whether or not a difference existed between said video image of said position and said reference image record of said position in said microprocessor system.

14. The method according to claim 13, wherein said camera of said camera system is mounted right behind one selected from a group consisting of said central reference point of said illumination system and a plurality of locations equally distanced from said central reference point respectively.

15. The method according to claim 13, wherein said area can be divided into a central area and at least one peripheral area according to distances away from said central reference point of said illumination system.

16. The method according to claim 13, wherein each of said peripheral area can be further divided into at least one sub-area according to distances and directions away from said central reference point of said illumination system.

17. The method according to claim 13, wherein said certain range having a size decided by a size of sensor of said camera and a requirement of inspecting resolution.

18. The method according to claim 13, wherein said flat thin lens is a Fresnel Lens and is placed in front of and tightly connected to said light emitting diodes to focus the lights emitted from said plurality of light emitting diodes onto any position of said printed circuit board.

19. The method according to claim 13, wherein said printed circuit board could be at any stage of a process for mounting electronic elements on said printed circuit board.
